(19) United States
(12) Patent Application Publication
(10) Pub. No.: US 2015/0113191 A1
(43) Pub. Date: Apr. 23, 2015

(54) RESOURCE SERIALIZATION IN A TRANSACTIONAL EXECUTION FACILITY

(71) Applicant: International Business Machines Corporation, Armonk, NY (US)

(72) Inventors: James H. Mulder, Wappingers Falls, NY (US); Peter J. Relson, Ulster Park, NY (US)

(73) Assignee: International Business Machines Corporation, Armonk, NY (US)

(21) Appl. No.: 14/055,936

(22) Filed: Oct. 17, 2013

(51) Int. Cl. G06F 9/46; G06F 9/48

(52) U.S. Cl. CPC G06F 9/466; G06F 9/48
USPC 710/267

(57) ABSTRACT

Embodiments include methods, systems and computer program products that include executing a begin transaction instruction to begin a transaction comprising a sequence of instructions, wherein the begin transaction instruction indicates that a resource will be accessed by the first processing device. Embodiments also include determining whether it is safe for the first processing device to access the resource. Based on a determination that it is safe for the first processing device to access the resource, embodiments include processing the sequence of instructions of the transaction. Based on a determination that the sequence of instructions of the transaction has been completed, embodiments include executing an end transaction instruction, wherein the end transaction instruction indicates that the first processing device has completed its access of the resource. Based on a determination that it is not safe for the first processing device to access the resource, embodiments include aborting the transaction.

### BACKGROUND

The present invention relates to controlling access to shared resources in a multiprocessing environment, and more specifically, to providing a protocol for resource serialization in a transaction execution facility.

In a contemporary multitasking, multiprocessing environment, resource serialization is a technique used to coordinate access to resources that are used by more than one application or processor. In general, applications that change stored data need exclusive access to the data. Otherwise, if several applications were to update the same data at the same time, the data could be corrupted. On the other hand, programs that need only to read data can safely share access to the same data at the same time.

There are several techniques for serializing the use of resources that are commonly used. These techniques allow for orderly access to system resources needed by an owner and users in a multiprogramming or multiprocessing environment. One common technique is the use of a serializing resource that can be obtained in shared and/or exclusive state, such as a system lock or a latch.

Another common technique for serializing the use of resources includes disabling external interrupts, known as a bindbreak method. FIGS. 2A and 2B illustrate flow diagrams of an existing bindbreak protocol for freeing a resource by the owner of the resource and for using a resource by a user of the resource, respectively. The bindbreak method serializes by having the owner of a resource wait for each processor in the multiprocessing environment to acknowledge having seen the owner's request to free the resource, coupled with each user following a protocol that involves not being enabled to receive external interrupts from the time that it checks to see if the control block can be used through the time that it is done with its use. Being disabled for external interrupts means that the receiver cannot run on that processor and thus defers the owner's processing until such time as disablement is dropped. In general, the bindbreak serialization method consumes a large amount of both time and CPU resources by sending external interrupts to all other processors and tracking receipt of external interrupts.

### SUMMARY

According to an embodiment, a computer-implemented method includes executing, on a first processing device, a begin transaction instruction to begin a transaction comprising a sequence of instructions, wherein the begin transaction instruction indicates that a resource will be accessed by the first processing device. The method also includes determining whether it is safe for the first processing device to access the resource. Based on a determination that it is safe for the first processing device to access the resource, the method includes processing the sequence of instructions of the transaction. Based on a determination that the sequence of instructions of the transaction has been completed, the method includes executing an end transaction instruction, wherein the end transaction instruction indicates that the first processing device has completed its access of the resource. Based on a determination that it is not safe for the first processing device to access the resource, the method includes aborting the transaction. Based on a determination that the sequence of instructions of the transaction has not been completed prior to receiving an abort instruction from an owner of the resource, the method includes aborting the transaction.

According to another embodiment, a computer system includes a first processing device configured to access a system having one or more resources, the first processing device configured to perform a method. The method includes executing a begin transaction instruction to begin a transaction comprising a sequence of instructions, wherein the begin transaction instruction indicates that a resource will be accessed by the first processing device. The method also includes determining whether it is safe for the first processing device to access the resource. Based on a determination that it is safe for the first processing device to access the resource, the method includes processing the sequence of instructions of the transaction. Based on a determination that the sequence of instructions of the transaction has been completed, the method includes executing an end transaction instruction, wherein the end transaction instruction indicates that the first processing device has completed its access of the resource. Based on a determination that it is not safe for the first processing device to access the resource, the method includes aborting the transaction. Based on a determination that the sequence of instructions of the transaction has not been completed prior to receiving an abort instruction from an owner of the resource, the method includes aborting the transaction.

According to another embodiment, a computer program product including a non-transitory computer readable storage medium having computer readable program code stored thereon that, when executed, performs a method. The method includes executing a begin transaction instruction to begin a transaction comprising a sequence of instructions, wherein the begin transaction instruction indicates that a resource will be accessed by the first processing device. The method also includes determining whether it is safe for the first processing device to access the resource. Based on a determination that it is safe for the first processing device to access the resource, the method includes processing the sequence of instructions of the transaction. Based on a determination that the sequence of instructions of the transaction has been completed, the method includes executing an end transaction instruction, wherein the end transaction instruction indicates that the first processing device has completed its access of the resource. Based on a determination that it is not safe for the first processing device to access the resource, the method includes aborting the transaction. Based on a determination that the sequence of instructions of the transaction has not been completed prior to receiving an abort instruction from an owner of the resource, the method includes aborting the transaction.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a computer system according to an embodiment;

FIG. 2A depicts a flow diagram of an existing bindbreak protocol for freeing a resource by the owner of the resource;

FIG. 2B depicts a flow diagram of an existing bindbreak protocol for using a resource by a user of the resource;

FIG. 3 depicts a block diagram of a transactional execution facility system according to an embodiment; and

FIG. 4 depicts a flow diagram of a transaction for resource serialization in a transactional execution facility according to an embodiment.

### DETAILED DESCRIPTION

Embodiments disclosed herein include a protocol for resource serialization in a transactional execution facility. The protocol allows a user to read from or write to an area of storage and allows an owner to free an area of storage, without both parties needing to obtain a serializing resource and/or requiring special authorization. In exemplary embodiments, the transactional execution facility makes it possible to have a protocol that does not obtain a serializing resource and does not need to disable for external interrupts while allowing the user to determine if the storage area to be referenced is safe to reference and allows the user to safely reference that storage area until the transaction is complete, knowing that the area cannot become invalid in the meantime.

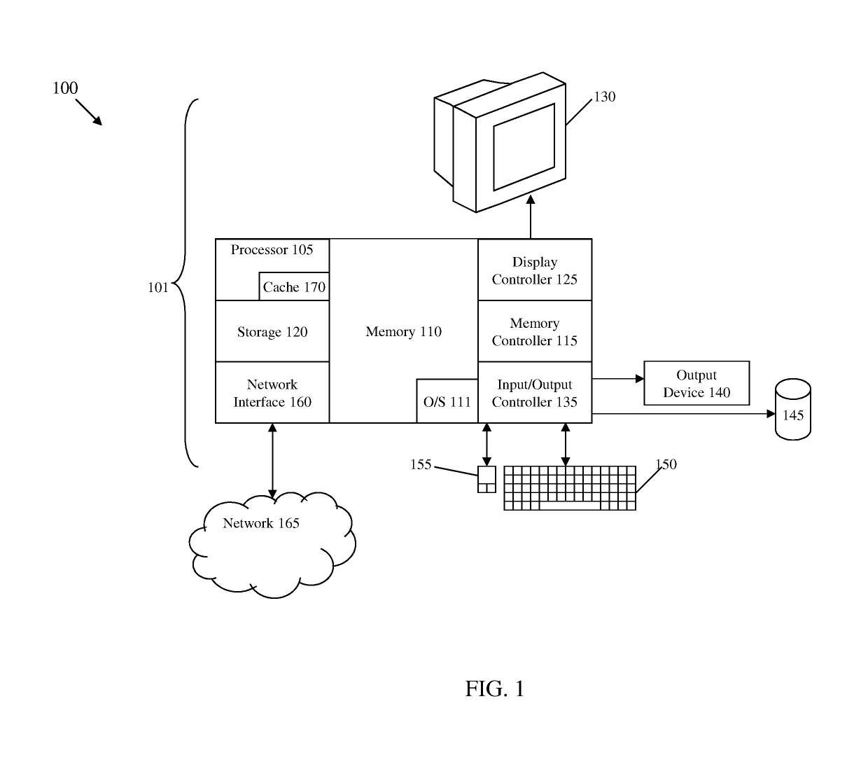

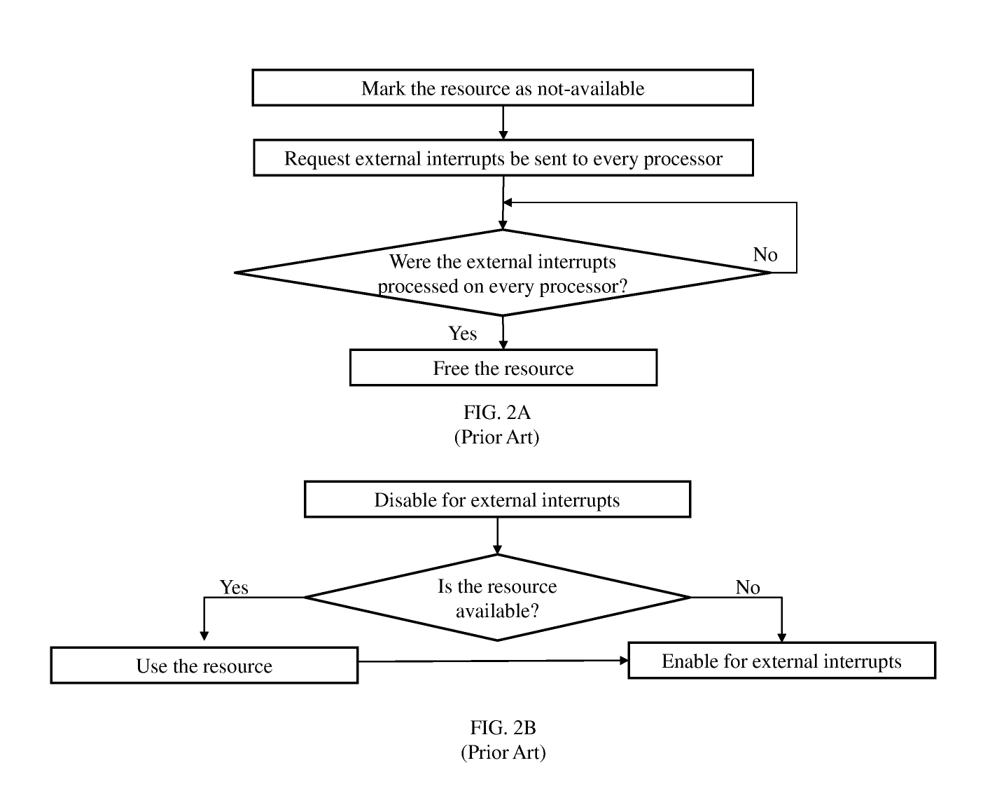

Referring now to FIG. 1, a block diagram of an exemplary computer system 100 for use with the teachings herein is shown. The methods described herein can be implemented in hardware software (e.g., firmware), or a combination thereof. In an exemplary embodiment, the methods described herein are implemented in hardware, and is part of the microprocessor of a special or general-purpose digital computer, such as a personal computer, workstation, minicomputer, or mainframe computer. The system 100 therefore includes general-purpose computer 101.

In an exemplary embodiment, in terms of hardware architecture, as shown in FIG. 1, the computer 101 includes a processor 105, memory 110 coupled via a memory controller 115, a storage device 120, and one or more input and/or output (I/O) devices 140, 145 (or peripherals) that are communicatively coupled via a local input/output controller 135. The input/output controller 135 can be, for example, but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The storage device 120 may include one or more hard disk drives (HDDs), solid state drives (SSDs), or any other suitable form of storage.

The processor 105 is a computing device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 may include a cache 170, which may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as Wi-Fi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the storage devices. The BIOS is stored in ROM so that the BIOS can be executed when the computer 101 is activated.

When the computer 101 is in operation, the processor 105 is configured to execute instructions stored within the memory 110, to communicate data to and from the memory 110, and to generally control operations of the computer 101 pursuant to the instructions.

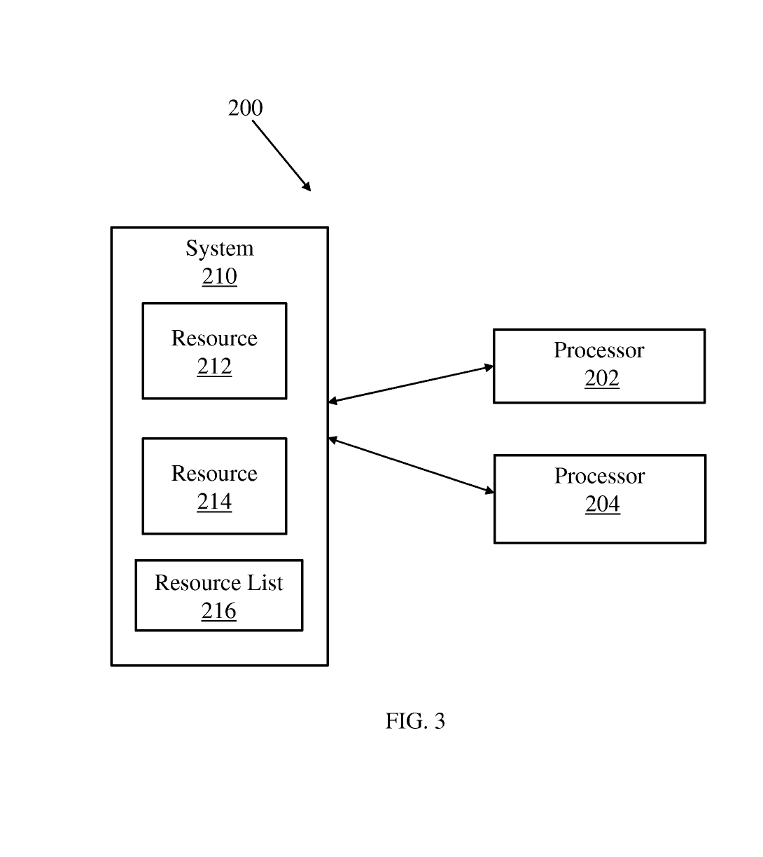

Referring now to FIG. 3, a block diagram of a transactional execution facility 200 is illustrated. The transactional execution facility 200 includes a first processor 202 and a second processor 204. In addition, the transactional execution facility 200 includes a system 210 that includes a first resource 212 and a second resource 214 that are configured to be used by both the first processor 202 and the second processor 204. In exemplary embodiments, the system 210 includes a resource list 216, which is configured to keep track of which processors 202, 204 are using each resource 212, 214. In addition, the resource list 216 may be used as a resource availability indicator which tracks whether it is safe for the processor 202, 204 to use the resources 212, 214.

In exemplary embodiments, during operation of the transactional execution facility 200 the first processor 202 or the second processor 204 may be considered either an owner or a user of one of the resources 212, 214. In exemplary embodiments, a user is configured to use the resource. For example, if the resource is an area of storage, a user is allowed to read from or write to the area of storage. In exemplary embodiments, an owner is configured to control the use of the resource. For example, if the resource is an area of storage, an owner is allowed to read from, write to, and free the area of storage.

In exemplary embodiments, the transactional execution facility 200 is configured to execute a function that involves the use of memory as the resource 212, 214. In exemplary embodiments the use of the transactional execution facility, referred to herein as a transaction, begins by one of the processors 202, 204 executing a transaction begin instruction and concludes by the processor executing a transaction end instruction. The transaction may include a sequence of instructions in which a processor utilizes a resource.

In exemplary embodiments, when a processor 202, 204 executes a transaction begin instruction to use a resource 212, 214, each of the other processors 202, 204 in the transactional execution facility 200 are notified that the processor is using the resource 212, 214. In one embodiment, if a processor has entered transactional execution mode and is using a resource, then that processor is notified of other processor's usage of that same resource. A processor enters the transactional execution mode by executing a transaction begin instruction and remains in the transactional execution mode until it is aborted or a transaction end instruction is executed. Likewise, when a processor 202, 204 executes a transaction end instruction, each of the other processors 202, 204 are notified that the processor is no longer in transactional execution mode. In one embodiment, the system 210 may be configured to keep track of this information in the resource list 216.

In exemplary embodiments, a transaction may be aborted during execution for various reasons, which include, but are not limited to, an external interrupt or a conflicting usage of storage by another processor. For example, if one processor is within a transaction and reads an area of storage and subsequently, but before the end of the transaction, another processor writes to that storage, the reading transaction will abort. In exemplary embodiments, when a transaction is aborted prior to being completed, all of the operations performed by the aborted transaction are reversed and the system 210 is restored to its pre-transaction state. In exemplary embodiments, after a transaction aborts the transaction is attempted again unless there is state information that indicates that it is not worthwhile.

In exemplary embodiments, a processor 202, 204 that is the owner of a resource 212, 214 is configured to free or release the release the resource 212, 214 by executing a freeing protocol. In exemplary embodiments, executing the freeing protocol update the resource list 216 maintained by the system 210 to indicate that it is not safe to use the resource. In addition, the freeing protocol may also include notifying each of the other processors in the transactional execution facility 200 that it is not safe to use the resource. After the resource list 216 of the system 210 has been updated, the freeing protocol concludes by freeing the resource. In exemplary embodiments, the freeing protocol can be executed by an owner of a resource at any time, including while the resource is being used by another processor. In exemplary embodiments, when an owner of a resource executes the freeing protocol while the resource is being used by another processor, the using processor will receive a signal to abort the transaction that it is executing and all operations performed by the using transaction will be reversed.

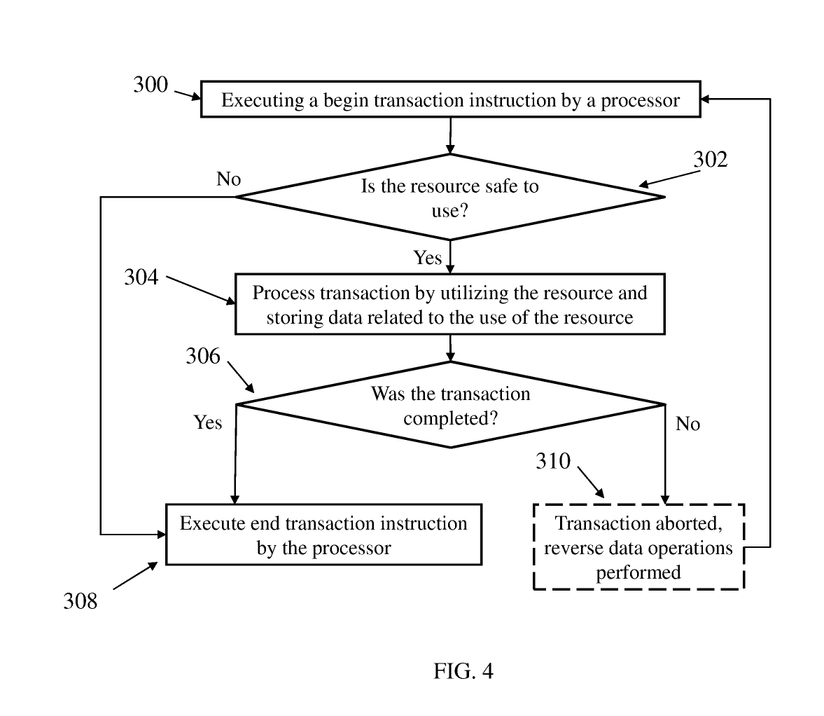

Referring now to FIG. 4, a flow diagram of a transaction for resource serialization in a transactional execution facility according to an embodiment is shown. As shown at block 300, the transaction begins by a processor executing a begin transaction instruction. Next, as shown at decision block 302, the transaction includes determining if the resource corresponding to the begin transaction instruction is safe to use. In exemplary embodiments, determining if the resource corresponding to the begin transaction instruction is safe to use includes checking a resource list maintained by the system, which is used to track the state of each resource in the transactional execution facility. If the resource is not safe to use, the method proceeds to block 308. Otherwise, if the resource is safe to use, the transaction proceeds to block 304 where the transaction is processed and the resource is utilized by the requesting processor. In exemplary embodiments, processing the transaction includes executing a sequence of instructions in which the processor utilizes the resource and storing data related to the use of the resource.

Next, at decision block 306, it is determined if the transaction has been completed. Once the transaction is completed, the transaction proceeds to block 308 where the processor executes an end transaction instruction. If the transaction is not successfully completed, the transaction proceeds to block 310 where the transaction is aborted and then proceeds to block 300 where a new transaction is initiated. In exemplary embodiments, when a transaction is aborted prior to being completed, all of the operations performed by the aborted transaction are reversed and the system 210 is restored to its pre-transaction state. In exemplary embodiments, when a transaction is aborted prior to being completed, the stores, or write operations, performed by the aborted transaction are rolled back and updated registers may be restored to their pre-transaction value.

In exemplary embodiments, using the transaction for resource serialization in a transactional execution facility requires less processing resources compared to the known techniques for implementing a bindbreak method. In addition, using the transaction for resource serialization in a transactional execution facility does not require authorization and does not require sending external interrupts to all other processors and tracking receipts of external interrupts.

An embodiment utilizes a transaction function provided by a Transaction Execution Facility (TEF) for resource serialization. Two special machine instructions mark the beginning (TBEGINC) and end (TEND) of the transaction. In between the TBEGINC and TEND instructions, a transaction can load and store from memory and alter registers. However, all the changes are provisional and uncommitted until the process ends the transaction without encountering an abort (e.g., a conflicting transaction or an interrupt). If an abort arises, the hardware aborts the transaction, including changes to memory, and the whole transaction starts over. According to an embodiment, the utilization of the transaction function ensures that, at some point, all the instructions of a transaction can be executed and completed on the same processor.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The disclosed flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A computer-implemented method, comprising:
executing, on a first processing device, a begin transaction instruction to begin a transaction comprising a sequence of instructions, wherein the begin transaction instruction indicates that a resource will be accessed by the first processing device;
determining whether it is safe for the first processing device to access the resource;
based on a determination that it is safe for the first processing device to access the resource, processing the sequence of instructions of the transaction;
based on a determination that the sequence of instructions of the transaction has been completed, executing an end transaction instruction, wherein the end transaction instruction indicates that the first processing device has completed its access of the resource;
based on a determination that it is not safe for the first processing device to access the resource, aborting the transaction; and
based on a determination that the sequence of instructions of the transaction has not been completed prior to receiving an abort instruction from an owner of the resource, aborting the transaction.

2. The computer-implemented method of claim 1, wherein the abort instruction from the owner of the resource includes an indication that it is no longer safe to use the resource.

3. The computer-implemented method of claim 1, wherein aborting the transaction includes rolling back operations performed during the transaction.

4. The computer-implemented method of claim 1, wherein executing the begin transaction instruction includes notifying one or more processing devices in a transaction execution facility that the first processing device is accessing the resource.

5. The computer-implemented method of claim 1, wherein determining whether it is safe for the first processing device to access the resource comprises looking up the resource in a resource list maintained by the first processing device.

6. The computer-implemented method of claim 5, further comprising based on receiving the abort instruction from the owner of the resource, updating the resource list to indicate that it is not safe to use the resource.

7. The computer-implemented method of claim 1, wherein the resource list comprises information regarding one or more processing devices using the resource and whether it is safe to use the resource.

8. A computer system, comprising:
a first processing device configured to access a system having one or more resources, the first processing device configured to perform a method comprising:
executing, on a first processing device, a begin transaction instruction to begin a transaction comprising a sequence of instructions, wherein the begin transaction instruction indicates that a resource will be accessed by the first processing device;
determining whether it is safe for the first processing device to access the resource;
based on a determination that it is safe for the first processing device to access the resource, processing the sequence of instructions of the transaction;
based on a determination that the sequence of instructions of the transaction has been completed, executing an end transaction instruction, wherein the end transaction instruction indicates that the first processing device has completed its access of the resource;
based on a determination that it is not safe for the first processing device to access the resource, aborting the transaction; and
based on a determination that the sequence of instructions of the transaction has not been completed prior to receiving an abort instruction from an owner of the resource, aborting the transaction.

9. The computer system of claim 8, wherein the abort instruction from the owner of the resource includes an indication that it is no longer safe to use the resource.

10. The computer system of claim 8, wherein aborting the transaction includes rolling back operations performed during the transaction.

11. The computer system of claim 8, wherein executing the begin transaction instruction includes notifying one or more processing devices in a transaction execution facility that the first processing device is accessing the resource.

12. The computer system of claim 8, wherein determining whether it is safe for the first processing device to access the resource comprises looking up the resource in a resource list maintained by the first processing device.

13. The computer system of claim 8, wherein the method further comprises updating the resource list to indicate that it is not safe to use the resource based on receiving the abort instruction from the owner of the resource.

14. A computer program product, comprising:
a non-transitory computer readable storage medium having computer readable program code stored thereon that, when executed, performs a method, the method comprising:
executing, on a first processing device, a begin transaction instruction to begin a transaction comprising a sequence of instructions, wherein the begin transaction instruction indicates that a resource will be accessed by the first processing device;
determining whether it is safe for the first processing device to access the resource;
based on a determination that it is safe for the first processing device to access the resource, processing the sequence of instructions of the transaction;
based on a determination that the sequence of instructions of the transaction has been completed, executing an end transaction instruction, wherein the end transaction instruction indicates that the first processing device has completed its access of the resource;
based on a determination that it is not safe for the first processing device to access the resource, aborting the transaction; and
based on a determination that the sequence of instructions of the transaction has not been completed prior to receiving an abort instruction from an owner of the resource, aborting the transaction.

15. The computer program product of claim 14, wherein the abort instruction from the owner of the resource includes an indication that it is no longer safe to use the resource.

16. The computer program product of claim 14, wherein aborting the transaction includes rolling back operations performed during the transaction.

17. The computer program product of claim 14, wherein executing the begin transaction instruction includes notifying one or more processing devices in a transaction execution facility that the first processing device is accessing the resource.

18. The computer program product of claim 14, wherein determining whether it is safe for the first processing device to access the resource comprises looking up the resource in a resource list maintained by the first processing device.

19. The computer program product of claim 18, the method further comprises updating the resource list to indicate that it is not safe to use the resource based on receiving the abort instruction from the owner of the resource

20. The computer program product of claim 14, wherein the resource list comprises information regarding one or more processing devices using the resource and whether it is safe to use the resource.
